(19) United States
(12) Patent Application Publication
(10) Pub. No.: US 2006/0171788 A1
(43) Pub. Date: Aug. 3, 2006

(54) Process and device for detecting a lubricant stream

(76) Inventors: Joachim Doerr, Weilheim (DE); Michael Lahres, Neu-Ulm (DE); Albert Loichinger, Gisingen (DE); Klaus Weinert, Baunatal (DE); Waldemar Zielasko, Nuertingen (DE)

Correspondence Address: AKERMAN SENTERFITT, P.O. BOX 3188, WEST PALM BEACH, FL, 33402-3188, US

(21) Appl. No.: 11/314,588

(22) Filed: Dec. 21, 2005

(30) Foreign Application Priority Data
Dec. 21, 2004 (DE) 102004061412.1-14

(51) Int. Cl. B23Q 11/12

(52) U.S. Cl. 409/135

(57) ABSTRACT

Process and device for detecting a lubricant stream in a minimal amount cooling lubricant system (MMKS). Known processes conduct the measurement in the MMKS-supply channel relatively far from the actual working location. They require an incorporation of sensors in the rotating tool container, which is very complex and associated with high costs. These disadvantages are overcome in that the measurement at the lubricant outlet occurs in a separate measurement container, wherein the aerosol component is measured optically and the lubricant film component is measured gravimetrically.

### BACKGROUND OF THE INVENTION

1. Field of the Invention

The invention concerns a process and a device for detecting a lubricant stream. One such process and a device of this type are already known from DE 10231300 A1.

2. Related Art of the Invention

In machining or metal cutting high frictional forces occur between the tool and the work piece, which leads to a pronounced evolution of thermal energy. For avoidance thereof it has for a long time been the conventional practice to employ lubricant. This was originally achieved in the form of full-stream lubrication, in which the lubricant was applied to the location being processed by a fluid stream. Today there is frequently employed a so-called minimal amount cooling lubrication (MMKS). Therein the smallest amount of lubricant (oil or fatty alcohol) is atomized into an aerosol and transported by means of airflow through an aerosol channel to the processing location. The MMKS exhibits a substantially reduced use of lubricant and therewith substantially smaller costs and environmental impact.

The lubricant amount is so small with MMKS that it cannot be monitored and quantified by an observer using only his eyes. This makes the functional monitoring of MMKS more difficult. Therewith there is the danger, that interruptions in function are not detected, or only detected too late, from which damage of the tool and work piece can result.

For this reason already different devices have been employed for monitoring the production of aerosol, for example, for monitoring the condition of the lubricant, the volume of flow of the lubricant to the aerosol producer and the volume flow of the air for the atomization of the lubricant into an aerosol.

A device of this type can however not detect small changes in the path from aerosol producer to processing location, which results for example from leakages, dead space, changes in cross section of the aerosol channel and mass forces acting upon the aerosol.

Thus, for better monitoring of the lubricant flow and the process and location, it was proposed in DE 10231300 A1 to incorporate two monitoring windows oriented angled relative to each other, which are provided perpendicular to the aerosol channel and make possible the monitoring of the aerosol by means of measuring of transmitted and scattered light. One such arrangement makes possible the determination of information regarding the lubricant stream of the aerosol, as well as the lubricant stream of a lubricant film on the inner wall of the aerosol channel which results from the precipitation of the aerosol.

The device of this type is however, for its part, located relatively far from the actual processing location.

On the other hand installation in a rotating tool holder is very complicated and associated with high costs. Beyond this, there is the danger that the lubricant film is interfered with in the transition from inner wall of the aerosol channel to the observation window, or that a tear or kink could occur in the channel, which could lead to an undesired reduction or constriction of the total lubricant stream.

### SUMMARY OF THE INVENTION

The task of the present invention is thus comprised therein, of providing an economical alternative for better determining the lubricant stream at the processing location.

These disadvantages are inventively overcome in that the measurement at the lubricant exit occurs in a separate measuring container, wherein the proportion of aerosol is optically measured and the lubricant film component is measured gravimetrically.

The task—with regard to the process to be provided for evaluating a lubricant stream in a lubricant device of a processing machine, wherein a first part of the lubricant is supplied to a tool as a lubricant-air-fog (aerosol) in an aerosol channel, wherein a second part of the lubricant is supplied to the tool as a lubricant film on the inner wall of the aerosol channel—is inventively solved thereby, that an instrument for measuring the lubricant stream is introduced in a measurement container, which is sealed relative to the environment, that the aerosol component of the lubricant stream is measured using an optical sensor system, that the lubricant film component of the lubricant stream is measured gravimetrically.

This process has the advantage, that both components of the lubricant stream are measured directly at the lubricant exit that is in closest proximity to the processing location. Beyond this, there is the advantage that no expensive conversion or rebuilding of the tool and incorporation or installation of sensor system (components) in the rotating system is necessary.

Suitable optical sensor systems are known. They can evaluate transmitted and/or scattered light signals. For this, suitable light impulses can be directed through the aerosol stream in the measurement container. Another possibility is comprised therein, that the aerosol is conveyed by means of a further air stream out of the measurement container to an external optical sensor system. In both types, the component of the floating or hovering lubricant droplets in the lubricant stream and the sequence thereof over time can be determined.

Suitable gravimetric sensor systems are likewise known. They can be comprised of a (weighing) scale integrated in the measurement container, which automatically relays its measurement results to an evaluation unit, or measurement container can be weighed at defined time intervals or periods, for example after decoupling of tool by means of a rapid connection. By means of the gravimetric sensor system the component of the lubricant stream of the not-hovering or not-floating lubricant droplets can be determined, which are comprised of lubricant film emitted from the lubricant exit and captured in the measurement container, as well as the time sequence thereof.

In particular, the measurement of changes over time of both components of the lubricant stream at the lubricant exit enables more precise information to be evaluated regarding possible losses or irregularities of the lubricant stream from the aerosol production to the aerosol emission location.

The individual components of the lubricant stream at the lubricant exit can then be combined in an evaluation unit into a total lubricant stream at the lubrication stream exit.

The measured components of the lubricant stream can respectively individually be taken into consideration in the control or monitoring of the total volume stream of the lubricant at the location of the aerosol production. Alternatively or additionally also the total lubricant stream can be employed as measurement value at the lubricant exit. The ability to add the two components takes into consideration the relationship of the floating aerosol droplets and the not-floating film droplets being components which together equal the total amount of the lubricant again, and the availability of all three values represents an optimal combination of control values. This allows—depending upon tool and RPM—an optimal adjustment of the lubricant stream at the location of the aerosol production and, via the feedback, a controlling also at the processing location. The precise recognition of quantity (total lubricant stream) and quality (relationship of the the floating lubricant droplets component of the lubricant stream to the not-floating lubricant film droplets component of lubricant stream) of the lubricant stream at the lubricant exit or, as the case may be, the processing location, is the basic precondition for realizing a reliable or secure processing in a series production.

The task, with regard to the device for determining a lubricant stream in a lubricant device of a machine, wherein the machine includes an aerosol channel, through which the lubricant is suppliable to a tool in a first part as lubricant air fog (aerosol) and as a second part as lubricant film on an inner wall of the aerosol channel, is inventively solved thereby, that the device includes a measurement container sealed relative to the environment, in which the instrument for determining of the lubricant stream is introducible, that the instrument includes an optical sensor system for determining the aerosol proportion of the lubricant stream, and that the instrument includes a gravimetric sensor system for determining the lubricant film component of the lubricant stream.

This device has the advantage, that, with it, both components of the lubricant stream are directly detectable at the lubricant exit, that is, in closest proximity to the processing location. Beyond this, no complex conversion of the tool and incorporation of sensor system (component) into the rotating system is necessary.

In a particularly advantageous embodiment of this device the optical sensor system and the gravimetric sensor system are connected with a control unit for the total volume stream of the lubricant at the location of the aerosol production.

This allows—depending upon tool and rotational speed—an optimal adjustment of the lubricant stream at the location of the aerosol production and, via the feedback the control, also at the processing location.

In the following the inventive process and the inventive device are described in greater detail on the basis of illustrative embodiments:

In this illustrative example a lubricant stream of fatty alcohol (2 to 200 ml/h) is provided at the lubricant exit of a rotationally driven, metal cutting MMKS-tool with internal aerosol channel. For monitoring or evaluation, an instrument is introduced in a measurement container. The measurement container is sealed against the environment with a burst seal. This prevents any interference with the aerosol stream during the measurement.

The aerosol stream comprised of floating lubricant droplets emitted at the lubricant outlet of the tool is measured in the upper area of the measurement container via a transport air stream conveyed by a guide hose to an optical sensor system. The optical sensor system is a laser scatter-light intensity measurement device, of which the measurement direction is perpendicular to the direction of flow through the aerosol stream. The optical sensor system determines the concentration of the aerosol, on the basis of the differential between the light intensity going through the aerosol stream and light intensity in the case of no aerosol stream, on the basis of an empiric determined reference table recorded or stored in an evaluation unit, respectively the lubricant stream, as well as their time sequence. The measurement values are relayed to an evaluation unit (PC). The aerosol amount produced over time as well as its measurements over time are likewise measured at the location of the aerosol production and relayed to the evaluation unit.

In the evaluation unit the two lubricant stream components at the lubricant outlet are combined and compared with the lubricant stream at the location of the aerosol production. This enables a good control or monitoring of the process guidance or management at the processing control, and an optimal control of the aerosol production corresponding to the respective requirements depending upon the selected tool and rotational speed.

The inventive process and the inventive device are, with respect to their construction, substantially simpler than known processes and devices and therewith also more economical. Besides this, the measurement location is located in the direct vicinity of the processing location and thus the measurement results are more representative.

The invention is not limited to the above described embodiment but rather is broadly applicable.

For application to a broad spectrum of manufacturing equipment different sized measurement containers can supplementally be made available, which can be fitted to different tools respectively with regard to inlet opening and seals, or can be adapted accordingly. Appropriate measures also apply for the supply connection from measurement container to optical sensor. For this, flexible hoses can be located or arranged with various lengths, or variably connectible fixed pipes can be employed.

1. A process for measuring a lubricant stream in a lubricant device of a machine, wherein a first component of the lubricant stream is supplied to a tool in the form of an aerosol in an aerosol channel, wherein a second part of the lubricant stream is supplied to the tool as lubricant film on the inner wall of the aerosol channel,
wherein an instrument for measuring the lubricant stream is introduced in a measurement container, which container is sealed relative to the environment,
wherein the aerosol component of the lubricant stream is ascertained using an optical sensor system, and
wherein the lubricant film component of the lubricant stream is ascertained gravimetrically.

2. A process according to claim 1, further comprising measuring the change over time of both components of the lubricant stream.

3. A process according to claim 1 further comprising taking into consideration the ascertained components of the lubricant stream for the control of the total volume stream of the lubricant at the location of the aerosol production.

4. A device for measuring a lubricant stream in a lubricant device of a machine, wherein the lubricant device includes
an aerosol channel, through which a first part of the lubricant is supplied to the tool as an aerosol and a second part as lubricant film on the inner walls of the aerosol channel,
a measurement container sealed relative to the environment,
an instrument for measuring the lubricant stream introduced in said container, said instrument including an optical sensor system for determining the aerosol component of the lubricant stream, and a gravimetric sensor system for determining the lubricant film component of the lubricant stream.

5. A device according to claim 4, wherein the optical sensor system and the gravimetric sensor system are connected to a control unit for controlling the total lubricant flow at the location of the aerosol production.
